(19) United States
(12) Patent Application Publication
(10) Pub. No.: US 2010/0265736 A1
(43) Pub. Date: Oct. 21, 2010

(54) FIBER OPTIC ENHANCED BALUSTER

(76) Inventor: Gregory B. Fox, Fontana, CA (US)

Correspondence Address: SHELDON MAK & ANDERSON PC, 100 Corson Street, Third Floor, PASADENA, CA, 91103-3842, US

(21) Appl. No.: 11/750,849

(22) Filed: May 18, 2007

(51) Int. Cl. F21S 8/00

(52) U.S. Cl. 362/565; 362/576

(57) ABSTRACT

A decorative baluster has (a) a body having one or more walls, an exterior surface and an enclosed central light well; (b) a fiber optic fan disposed proximate to the light well, the fiber optic fan comprising a plurality of fiber optic fibers, each fiber optic fiber having an interior termination point disposed proximate to the light well and an opposed exterior termination point disposed proximate to the exterior surface of the body such that each exterior termination point is visible along the exterior surface of the body; and (c) an artificial light source disposed within the light well such that light emitted from the artificial light source is directed to the interior origination point of each fiber optic fiber.

### SUMMARY OF THE INVENTION

The invention is a decorative baluster comprising (a) a body having one or more walls, an exterior surface and an enclosed central light well; (b) a fiber optic fan disposed proximate to the light well, the fiber optic fan comprising a plurality of fiber optic fibers, each fiber optic fiber having an interior termination point disposed proximate to the light well and an opposed exterior termination point disposed proximate to the exterior surface of the body such that each exterior termination point is visible along the exterior surface of the body; and (c) an artificial light source disposed within the light well such that light emitted from the artificial light source is directed to the interior origination point of each fiber optic fiber. In the invention, light from the artificial light source is received by the interior origination point of each fiber optic fiber and transmitted to the exterior termination point of each fiber optic fiber so that the exterior termination point of each fiber optic fiber is illuminated and visible at the exterior surface of the body.

### DESCRIPTION OF THE DRAWINGS

FIG. 1 is a top view of a decorative baluster having features of the invention;

FIG. 2 is an elevational view showing the back side of the decorative baluster illustrated in FIG. 1;

FIG. 3 is an elevational view showing a cross-sectional side view of the decorative baluster illustrated in FIG. 1;

FIG. 4 is a perspective view of the decorative baluster illustrated in FIG. 1; and

FIG. 5 is a bottom view of the decorative baluster illustrated in FIG. 1.

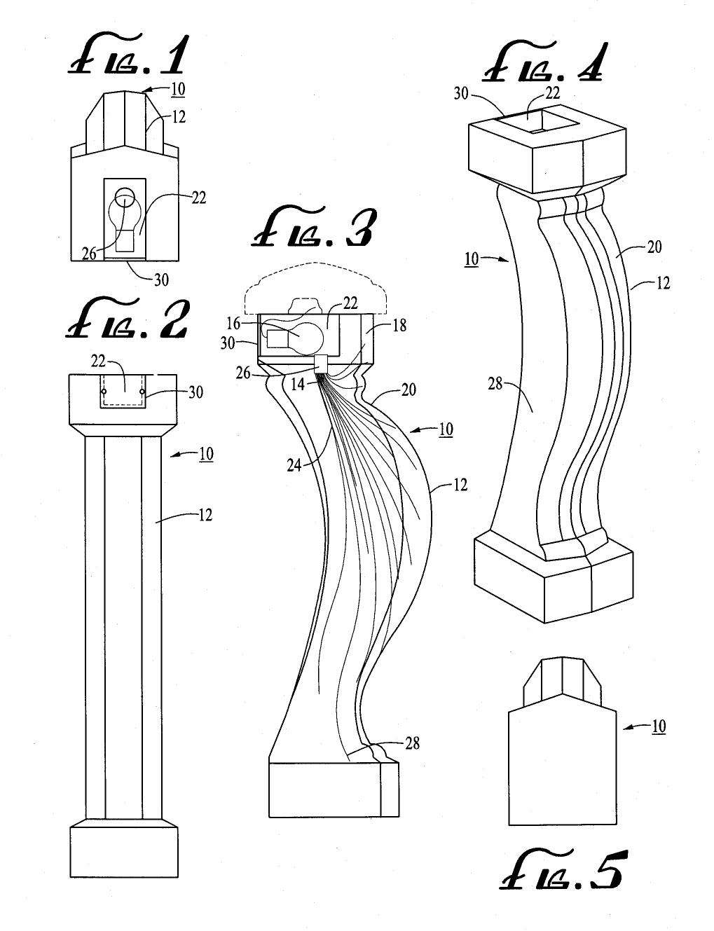

### DETAILED DESCRIPTION OF THE INVENTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a decorative baluster 10 comprising a body 12, a fiber optic fan 14 and an artificial light source 16.

The body 12 can be cast or lathed. The body 12 can be constructed from concrete, polyester resin, reinforced resin, ceramic material, molded plastic or other material suitable for casting and molding into a baluster shape.

The body 12 comprises one or more walls 18 and an exterior surface 20. The body 12 further comprises an enclosed central light well 22.

The fiber optic fan 14 is disposed proximate to the light well 22. The fiber optic fan 14 comprises a plurality of fiber optic fibers 24. Each of the fiber optic fibers 24 has an interior termination point 26 disposed proximate to the light well 22 and an opposed exterior termination point 28 disposed proximate to the exterior surface 20 of the body 12 such that each exterior termination point 28 is visible along the exterior surface 20 of the body 12. In the embodiment illustrated in the drawings, the interior termination point 26 of each fiber optic fiber is disposed tangent with the bottom of the light well 22.

The artificial light source 16 is disposed within the light well 22 such that light emitted from the artificial light source 16 is directed to the interior origination point 26 of each of the fiber optic fibers 24. In the embodiment illustrated in the drawings, the artificial light source 16 is a common incandescent light bulb. Other forms of artificial light source 16, such as LEDs, can also be used.

In the embodiment illustrated in the drawings, the light well 22 is covered by a posterior plate 30 to minimize weathering of the artificial light source 16. The posterior plate 30 is preferably easily removable for ready access to the light well 22.

The artificial light source 16 is typically powered via electrical wires disposed under a banister top rail (not shown).

A baluster 10 of the invention can be conveniently manufactured by molding in a baluster shape mold. The baluster shape mold includes a light well shape projecting into the mold with volume enough to hold the artificial light source 16 apparatus. The light well 22 must also allow for a void large enough to hold a clamp or grommet in which is held an optical fiber bundle during casting.

The fiber optic bundle is fanned out from a mounting within the mold void. The exterior termination point 28 of each fiber optic fiber 24 is disposed along the outside surface plane of the mold where it can be made flush with the final casting surface 20 after the molding process is completed.

The baluster shape mold can be filled with one or more materials including: concrete, polyester resin, reinforced resin, ceramic material, molded plastic or any other moldable material suitable for casting and holding a baluster shape. The chosen material is then used to fill the suitable baluster mold which has had an optical fiber bundle mounted to the light well 22 portion of the mold. Once the baluster cast is released from its mold the optical fibers 24 can be cut and/or sanded flush with the outside surface 20 of the baluster 10. Specific baluster 10 installation is dependent on choice of materials used to cast the balusters 10.

The invention provides a decorative baluster which can be illuminated from within, thereby creating a stippled light effect. Because the stippled lighting effect is created by an internal electrical apparatus, the decorative baluster of the invention minimizes the danger of electrical shock due, in prior art decorative balusters, to cords disposed around the outside of the baluster 10. The decorative balusters 10 of the invention can take the place of unenhanced balusters in any architectural setting both indoors and outdoors.

Having thus described the invention, it should be apparent that numerous structural modifications and adaptations may be resorted to without departing from the scope and fair meaning of the instant invention as set forth hereinabove.

What is claimed is:

1. A decorative baluster comprising:
(a) a body having one or more walls, an exterior surface and an enclosed central light well;
(b) a fiber optic fan disposed proximate to the light well, the fiber optic fan comprising a plurality of fiber optic fibers, each fiber optic fiber having an interior termination point disposed proximate to the light well and an opposed exterior termination point disposed proximate to the exterior surface of the body such that each exterior termination point is visible along the exterior surface of the body; and
(c) an artificial light source disposed within the light well such that light emitted from the artificial light source is directed to the interior origination point of each fiber optic fiber;
whereby light from the artificial light source is received by the interior origination point of each fiber optic fiber and transmitted to the exterior termination point of each fiber optic fiber so that the exterior termination point of each fiber optic fiber is illuminated and visible at the exterior surface of the body.

2. A decorative baluster as in claim 1 comprises of cement and aggregate.

3. A decorative baluster as in claim 1 comprised of polyester resin with fillers.

4. A decorative baluster as in claim 1 comprised of ceramic material.

5. A decorative baluster as in claim 1 comprised of moldable plastic.

6. A decorative baluster as in claim 1 is safer than using an external lighting apparatus to produce a stippled light affect.
